(19) United States
(12) Patent Application Publication
(10) Pub. No.: US 2018/0028036 A1
(43) Pub. Date: Feb. 1, 2018

(54) CONSUMER SCRUBBING ARTICLES WITH CERAMIC MICROPARTICLES AND METHOD OF MAKING SAME

(71) Applicant: 3M INNOVATIVE PROPERTIES COMPANY, St. Paul, MN (US)

(72) Inventors: Paul N. Daveloose, Maplewood, MN (US); Matthew S. Cole, Woodbury, MN (US); Ibrahim S. Gunes, Minneapolis, MN (US); Baris Yalcin, Roswell, GA (US)

(73) Assignee: 3M INNOVATIVE PROPERTIES COMPANY, St. Paul, MN (US)

(21) Appl. No.: 15/551,988

(22) PCT Filed: Feb. 4, 2016
(86) PCT No.: PCT/US2016/016525

§ 371 Date: Aug. 18, 2017

Related U.S. Application Data
(60) Provisional application No. 62/121,644, filed on Feb. 27, 2015.

(51) Int. Cl. A47L 13/16; B24D 11/00; C08J 7/12; B05D 5/02; A47L 17/08; C08K 7/28

(52) U.S. Cl. CPC A47L 13/16; A47L 17/08; C08K 7/28; C08J 7/123; B05D 5/02; B24D 11/001; C08J 2313/02; B05D 1/32

(57) ABSTRACT

A scrubbing article 10 including a substrate 12 and a texture layer 14. The texture layer 14 is formed on to a surface 16 of the substrate 12 and includes a multiplicity of microparticles. In some embodiments, the multiplicity of microparticles comprises plastic microbubbles and/or ceramic microspheres that are substantially spherical. In related embodiments, at least some of the ceramic microspheres are solid, and in other embodiments at least some of the ceramic microspheres are glass microbubbles. The substrate 12 can assume various forms, such as nonwoven, fabric (e.g., woven or knitted), foam, film and sponge material or combinations thereof.

### BACKGROUND

The present disclosure relates to a scrubbing article having a textured surface. More particularly, it relates to scrubbing articles having a texture layer with enhanced surface treating capabilities and abrasion resistance.

A variety of cleaning articles in the form of pads and wipes have been developed and made commercially available for household and industrial use. Consumers oftentimes desire to use the articles for cleaning or surface treating tasks requiring scrubbing that in turn may include various degrees of abrading and/or scouring. For example, it can be difficult, if not impossible, to remove dried food from a countertop using an inherently soft article. Conversely, however, consumers strongly prefer that the article not be overly rigid. In some cases, consumers thus desire that the article be drapeable for ease of use. Furthermore, consumers often desire a scrubbing pad or wipe that is not overly abrasive on relatively soft or easily scratched surfaces. In addition, consumers often find cleaning articles that are pre-loaded with a cleaning/disinfecting/sanitizing chemical or chemicals to be extremely useful and convenient.

Scrubbing articles have been developed to address some of the above-identified desires and concerns. For example, U.S. Pat. No. 7,829,478 to Johnson et al. describes a scrubbing wipe article including a nonwoven substrate and a texture layer. The texture layer is a non-crosslinked, abrasive resin-based material that is printed onto at least one surface of the nonwoven substrate. Johnson et al. teach that the texture layer composition is printed onto the substrate and then caused to coalesce to bond the composition to the substrate. Johnson et al. further describe that the resin constituent does not crosslink as part of the coalescing step and that coalescing represents a distinct advantage over other scrubbing wipe article forming techniques in which a lengthy curing period is required to achieve a sufficient hardness value. The scrubbing wipe article of Johnson et al. can be used “dry” or can be loaded with a chemical solution.

Other cleaning wipe constructions include or incorporate mildly abrasive particles within or at a surface of the base substrate. For example, U.S. Pat. No. 5,213,588 to Wong et al. describes an abrasive wipe consisting of a paper towel-like base substrate having printed thereon a mixture containing irregularly-shaped polymeric particles. Improvements in the properties of the scrubbing surface (e.g., an imparted texture layer) of a scrubbing article may be beneficial and therefore desirable. A need therefore exists for a scrubbing article that includes the benefits and advantages of a textured surface with enhanced abrasion resistance for scrubbing applications.

### SUMMARY

Some aspects of the present disclosure are directed toward a scrubbing article including a substrate and a texture layer. The texture layer is formed on a surface of the substrate and includes a multiplicity of ceramic microparticles. In some embodiments, the multiplicity of ceramic microparticles comprises ceramic microspheres that are substantially spherical. In related embodiments, at least some of the ceramic microspheres are solid, and in other embodiments at least some of the ceramic microspheres are glass microbubbles. In additional embodiments, the texture layer includes a multiplicity of plastic microbubbles. The substrate can assume various forms, such as nonwoven, fabric (e.g., woven or knitted), foam, film and sponge material or combinations thereof. Other aspects of the present disclosure are directed toward a method of manufacturing a scrubbing article. The method includes providing a substrate. A texture layer is formed on to a surface of the substrate, and includes a multiplicity of ceramic microparticles. In some embodiments, the step of forming the texture layer includes providing a flowable texture layer composition and forming the texture layer composition on to the substrate surface. In related embodiments, some methods of the present disclosure include subjecting the formed texture layer to conditions that effectuate crosslinking; in other methods, the texture layer is not crosslinked. Regardless, the multiplicity of microparticles beneficially contribute to scrubbiness and abrasion resistance characteristics of the scrubbing article, and non-limiting examples include substantially spherical solid ceramic microspheres, substantially spherical glass microbubbles and/or plastic microbubbles.

### BRIEF DESCRIPTION OF THE DRAWINGS

FIG. 1 is a perspective view of an exemplary scrubbing article in accordance with principles of the present disclosure;

FIG. 1A is an enlarged plan view of a portion of the surface of the scrubbing article of FIG. 1;

FIG. 2 is an enlarged, cross-sectional view of a portion of the article of FIG. 1 along the lines 2-2, shown in FIG. 1;

FIG. 3 is an enlarged, cross-sectional view of the article portion of FIG. 2 being applied to a surface;

FIG. 4 is a simplified illustration of a method of manufacture in accordance with principles of the present disclosure; and

FIGS. 5A-5B are top views of alternative embodiments of a scrubbing article in accordance with principles of the present disclosure.

### DETAILED DESCRIPTION

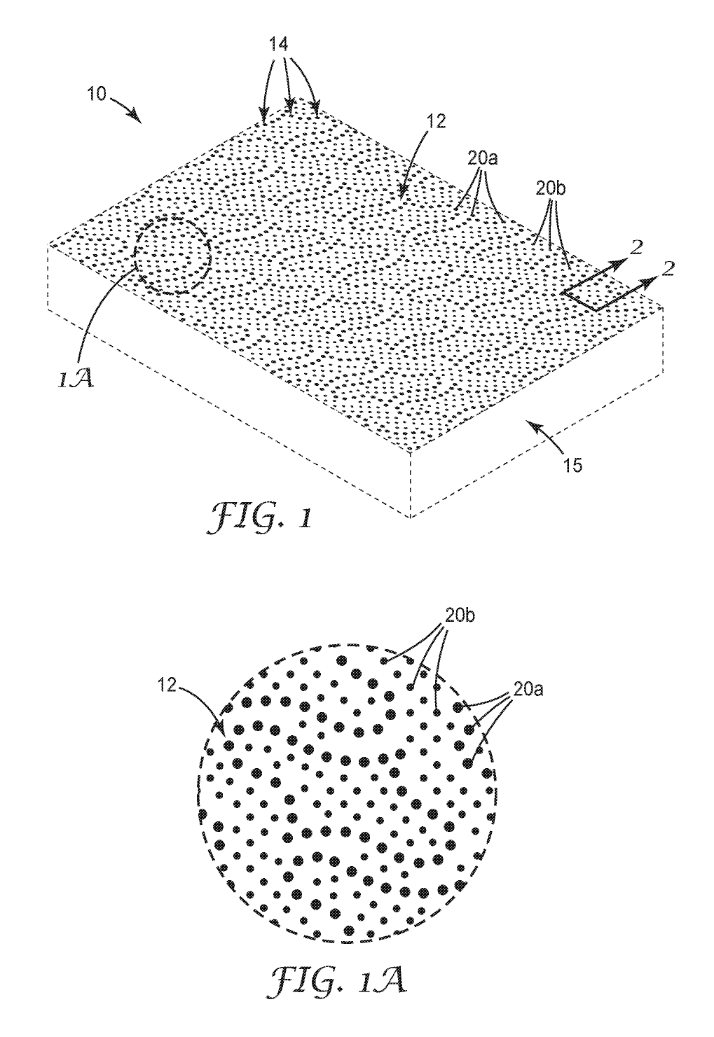

FIG. 1 illustrates an embodiment of a scrubbing article 10 in accordance with the present disclosure. Scrubbing article 10 may be described as a consumer cleaning or scrubbing article 10. As used throughout this Specification, the term “consumer” is in reference to any household, cosmetic, industrial, hospital or food industry applications and the like of the article 10. Certain embodiments can be used as floor pads or hand pads, for example. Further as used throughout this Specification, the term “scrubbing” is used to describe surface treating and may include cleaning, abrading and/or scouring, including various levels or degrees of abrading and/or scouring action (e.g., heavy duty, non-scratch, etc.). The article 10 comprises a substrate 12 and a texture layer 14 (referenced generally in FIG. 1). The substrate 12 and the texture layer 14 can comprise a variety of different materials as described further below. Regardless, the texture layer 14 is formed on and perhaps at least penetrates the substrate 12 and includes a multiplicity of microparticles (not individually visible as the scale of the view of FIG. 1) as will be described more fully below. As a point of reference, FIG. 1 further reflects that the scrubbing article 10 can optionally include one or more complimentary bodies 15 (drawn in phantom) to which the substrate 12 is attached. The substrate 12 and the auxiliary body 15 can be formed of differing materials (e.g., the substrate 12 is a nonwoven material and the auxiliary body 15 is a sponge). In other embodiments, the auxiliary body 15 is omitted.

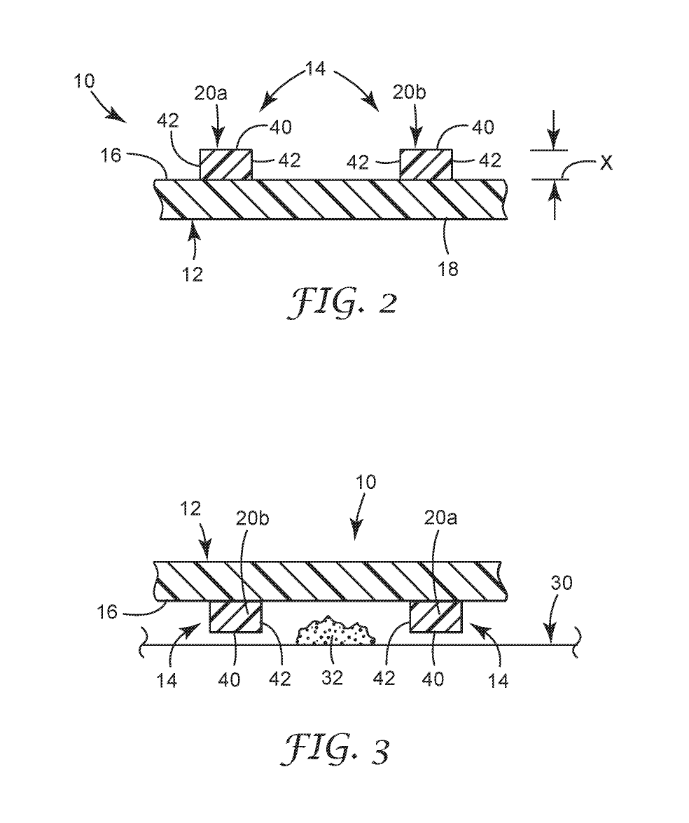

With additional reference to FIG. 2, the substrate 12 defines first and second opposing surfaces 16, 18. For purposes of illustration, thicknesses of the substrate 12 and the texture layer 14 may be exaggerated or understated in FIG. 2. The texture layer 14 can be formed on one or both of the substrate surfaces 16, 18. In some embodiments, the scrubbing article 10 further includes a chemical solution (not shown) loaded into, or absorbed by, the substrate 12 and/or the optional auxiliary body 15. Applicable chemical solutions are likewise described in greater detail below. The texture layer 14 may be configured to accommodate a wide variety of chemical solutions including those that are neutral, cationic, or anionic. Further, the scrubbing article 10 is equally useful without a chemical solution.

Compositions of the substrate 12 and the texture layer 14, as well as processing thereof, are provided below. The scrubbing article 10 may be described as providing a “scrubbiness” attribute. The term “scrubbiness” is in reference to an ability to abrade or remove a relatively small, undesirable item otherwise affixed to a surface as the article is moved back and forth over the item. A substrate can be given a scrubbiness characteristic not only by forming a hardened scrubbing material on the substrate's surface (i.e., harder than the substrate 12 itself), but also and perhaps more prominently via the extent to which the so-formed material extends from or beyond the substrate surface in conjunction with side-to-side spacing between individual sections of the scrubbing material.

By way of further explanation, the texture layer 14 defines a plurality of discrete portions such as dots or islands (e.g., the various dots shown in FIG. 1 and referenced generally at 20a, 20b). Discrete portions 20a, 20b may form a randomly textured surface or may form a discernable pattern on the substrate surface 16. Further, discrete portions (e.g., 20a, 20b) may comprise varying relative sizes or may be substantially uniform in size. For instance, and as illustrated more clearly in FIG. 1A, dots 20a are relatively larger than dots 20b. Further, discrete portions (e.g., 20a, 20b) may extend or project outwardly from the surface 16 at substantially uniform distances or, alternatively, may extend or project outwardly from the surface 16 at varying distances (i.e. the discrete portions 20a, 20b can have similar or varying heights with respect to the surface 16). In some embodiments, discrete portions (e.g., 20a, 20b) may extend to any distance in a range of about 10 to about 500 microns outwardly from the surface 16. In other embodiments, discrete portions (e.g., 20a, 20b) may extend at least 10, at least 50 or at least 500 microns outwardly from the surface 16. In still further embodiments, discrete portions (e.g., 20a, 20b) may extend to a distance of 10-20 microns or less outwardly from the surface 16. Regardless of the pattern, design and/or extension distance of portions (e.g., 20a, 20b) from the surface 16, during a scrubbing application, a user (not shown) will normally position the scrubbing article 10 such that the texture layer 14 is facing the surface to be scrubbed. An example of this orientation is provided in FIG. 3 whereby the scrubbing article 10 is positioned to clean or otherwise treat a surface 30. As should be understood, the surface 30 to be cleaned is application specific, and can be relatively hard (e.g., a table top or cooking pan) or relatively soft (e.g., human skin, polymeric baking vessels, etc.). Regardless, in the exemplary embodiment of FIG. 3, the surface 30 to be scrubbed may have a mass 32 that is undesirably affixed thereto. Again, the mass 32 will be unique to the particular scrubbing application, but includes matters such as dirt, dried food, dried blood, etc. The scrubbing article 10 of the present disclosure facilitates scrubbing removal of the mass 32 as a user repeatedly forces the texture layer 14 (or a portion thereof) back and forth across the mass 32. Each section (for example, the sections 20a, 20b) of the texture layer 14 must be sufficiently hard to either abrade or entirely remove the mass 32 during the scrubbing motion. In addition, the texture layer 14 must extend an appreciable distance from the substrate surface 16 to ensure intimate surface interaction with the mass 32 along not only an outer most surface 40, but along sides 42 as well. Portions 20a, 20b, while depicted as having uniform, sharp corners or edges (at the intersection of surface 40 and sides 42), may likewise or instead have rounded edges or corners or may be non-uniform in cross-section. What is important is that the extension of the texture layer is such that the desired scrubbiness is achieved. Notably, many cleaning wipes incorporating a blown fiber “scrubbing” or texture layer provide only a minimal thickness or extension relative to the substrate surface, likely giving rise to a less than desirable scrubbiness characteristic. Further, it is preferred that the discrete portions (for example, the portions 20a, 20b) provided by the texture layer 14 of the present disclosure be sufficiently spaced from one another to ensure intimate contact between the mass 32 and the sidewall 42 of the particular texture layer portion 20a, 20b during a cleaning operation. Further still, it is desirable that the texture layer 14 has abrasion resistance such that the composition forming the texture layer 14 remains substantially intact on the substrate 12 during and after the article 10 is used to scrub the surface 30.

### Substrates

The substrate 12 may be formed from a variety of materials and in a variety of forms. Any substrate material or combination of materials suitable for use as a consumer scrubbing article can be used including, without limitation, various nonwoven, fabric (e.g., woven or knitted), foam, sponge and film materials. The materials and forms of the substrate 12 can be selected to provide varying ranges of desired properties, such as extensibility, elasticity, durability, flexibility, printability, etc., that are particularly suited to a given scrubbing task and/or are particularly suited to depositing or forming a texture layer composition thereon. As indicated, materials useful for substrate 12 may be selected to have durability properties in a wide range. For example, the durability of materials suitable for use in scrubbing articles is often categorized as “disposable” (meaning that an article formed from the material is intended to be discarded immediately after use), “semi-disposable” (meaning that an article formed from the material can be washed and re-used a limited number of times), or “reusable” (meaning that an article formed from the material is intended to be washed and re-used). As also indicated above, materials may be selected based upon their flexibility. Depending upon the application, consumers may prefer a relatively flexible, supple or drapable scrubbing article, whereas in other applications, consumers prefer a relatively more rigid article that still maintains some degree of flexibility. In applications where a relatively more supple scrubbing article is preferred (e.g., drapable), providing a more flexible substrate 12 allows the user to readily fold, squeeze, or otherwise manipulate the scrubbing article 10 in a manner most appropriate for the particular scrubbing task. The desired suppleness of the substrate 12 can be characterized by reference to a dry basis weight thereof. With optional embodiments in which the substrate 12 is a nonwoven material, the nonwoven substrate 12 can have a dry basis weight of less than about 300 g/m², alternatively less than about 200 g/m², and greater than about 30 g/m². “Drapability” is defined as the inherent ability to conform to an irregular or non-flat surface. Alternatively, the suppleness of the substrate 12 can be expressed in terms of drapability. Drapability or “drape” is measured using INDA standard for “Handle-O-Meter Stiffness of Nonwoven Fabrics” IST 90.3 (95). With this in mind, the nonwoven versions of the substrate 12 can have a drapability value of less than about 250 in some embodiments. In other embodiments for scrubbing applications where a relatively stiffer, yet still flexible substrate is desired, the substrate 12 may be formed of a composition and into a form that substantially holds its shape both when held lightly by a user or when placed on an irregular surface.

Some exemplary substrates 12 will now be described, however, a wide variety of materials may be used for the substrate 12, as noted above. Exemplary fabrics useful with the present disclosure include knitted fabrics, such as a knitted fabric prepared from 82% poly(ethylene terephthalate) and 18% polyamide 6 fibers having a thickness in a range of 0.45-0.75 mm and a unit weight of 160 grams per square meter. Another exemplary fabric is described in U.S. Provisional Patent Application having Attorney Docket No. 76147US002, entitled, “Multipurpose Consumer Scrubbing Cloths and Methods of Making Same” filed on even date herewith and incorporated by referenced herein in its entirety.

In other embodiments, the substrate 12 can be or can include a nonwoven material or web. With nonwoven embodiments, and in most general terms, the substrate 12 is comprised of individual fibers entangled with one another (and optionally bonded) in a desired fashion. The fibers are preferably synthetic or manufactured, but may include natural materials such as wood pulp fiber. As used herein, the term “fiber” includes fibers of indefinite length (e.g., filaments) and fibers of discrete length (e.g., staple fibers). The fibers used in connection with a nonwoven version of the substrate 12 may be multicomponent fibers. The term “multicomponent fiber” refers to a fiber having at least two distinct longitudinally coextensive structured polymer domains in the fiber cross-section, as opposed to blends where the domains tend to be dispersed, random, or unstructured. The distinct domains may thus be formed of polymers from different polymer classes (e.g., nylon and polypropylene) or be formed of polymers of the same polymer class (e.g., nylon) but which differ in their properties or characteristics. The term “multicomponent fiber” is thus intended to include, but is not limited to, concentric and eccentric sheath-fiber structures, symmetric and asymmetric side-by-side fiber structures, island-in-sea fiber structures, pie wedge fiber structures, and hollow fibers of these configurations.

In addition to the availability of a wide variety of different types of fibers useful for a nonwoven version of the substrate 12, the technique for bonding the fibers to one another is also extensive. In general terms, suitable processes for making a nonwoven version of the substrate 12 that may be used in connection with some embodiments of the present disclosure include, but are not limited to, spunbond, blown microfiber (BMF), thermal bonded, wet laid, air laid, resin bonded, spunlaced, ultrasonically bonded, etc. In some embodiments, the nonwoven version of the substrate 12 is spunlaced utilizing a fiber sized in accordance with known spunlace processing techniques. With this manufacturing technique, one optional construction of the nonwoven version of the substrate 12 is a blend of 50/50 wt. % 1.5 denier polyester and 1.5 denier rayon at 50-60 g/m². The nonwoven substrate 12 is first carded and then entangled via high-pressure water jets as is known in the art. The spunlace technique eliminates the need for a thermal resin bonding component, so that the resulting nonwoven substrate is amenable to being loaded with virtually any type of chemical solution (i.e., anionic, cationic, or neutral). Other nonwoven constructions and methods of manufacture are equally acceptable and can include, for example, a thermally point-bonded spunbond poly(ethylene terephthalate) nonwoven wipe.

In other embodiments, the substrate 12 is or includes a foam. An example foam useful with the present disclosure as, or as part of, the substrate 12 is a polyurethane foam having relatively non-porous top and bottom surfaces, commercially available under the trade designation of “TEXTURED SURFACE FOAM, POLYETHER, M-100SF” from Aearo Technologies, LLC, Newark, Del., USA.

In other embodiments, the substrate 12 is or includes a sponge. Exemplary sponges useful with the present disclosure are the cellulose sponges commercially available under the trade designations “SCOTCH-BRITE Stay Clean Non-Scratch Scrubbing Dish Cloth” (having catalog number 9033-Q) and “SCOTCH-BRITE Stay Clean Non-Scratch Scrub Sponge” (catalog number of 20202-12), both from 3M Company, St. Paul, Minn., USA.

In yet other embodiments, the substrate 12 is or includes a film, such as single layer or multi-layered polymer films made by extrusion, solvent casting, calendaring, stretching (e.g., via a tenter or stretching frame) and by other customary polymer processing method, are useful with the present disclosure. Some exemplary films include a plastic film made of melt-extruded, biaxially oriented and primed poly(ethylene terephthalate), polyolefin films, elastomeric films made of physically and chemically cross-linked elastomers, films made of vinyl monomers, such as poly(vinyl chloride), poly(vinylidene chloride) (which is commonly known under the trade designation “SARAN” or “SARAN WRAP” from S.C. Johnson & Son of Racine, Wis.), fluoropolymers, such as poly(vinylidene fluoride), silicones, polyurethanes, polyamides, poly(lactic acid), and combinations thereof.

Other fabrics, sponges, foams, films, wovens and nonwovens are likewise contemplated and the above examples are not meant to be limiting. Regardless of the exact construction, however, the substrate 12 is highly conducive to handling by a user otherwise using the article 10 for scrubbing purposes and is selected having regard to the intended use of the scrubbing article 10.

Although the substrate 12 is depicted in the cross-sectional view of FIG. 2 as a single layer structure, it should be understood that the substrate 12 may be of single or multi-layer construction. If a multi-layered construction is used, it will be understood that the various layers may have the same or different properties, constructions, etc., as is known in the art. For example, in one alternative embodiment, the substrate 12 is constructed of a first layer of 1.5 denier rayon and a second layer of 32 denier polypropylene. This alternative construction provides a relatively soft substrate, such that the resulting wiping article 10 is conducive for use cleaning a user's skin, akin to a facial cleansing wipe. In yet other embodiments, as mentioned above with respect to the optional auxiliary body 15 of FIG. 1, the substrate 12 can be connected or attached to a number of other substrate bodies presenting beneficial cleaning or handling properties. In further embodiments, the substrate 12 may also include an adhesion promoter layer or a tie layer, for example.

### Texture Layer Compositions

As discussed above, the texture layer 14 is an abrasive composition that is imparted to and, perhaps, at least partially penetrating the substrate 12. The exact composition of the texture layer 14 can vary depending upon desired end performance characteristics. To this end, a texture layer composition is initially formulated, and then deposited or formed on the substrate 12, and then solidifies (active or passive) to complete the texture layer 14. As a point of reference, the “texture layer composition” (or a “texture layer matrix”) means the components or ingredients upon final mixing and before application or formation at (e.g., printing, coating, embossing, micro-replication, etc.) the substrate 12. The “texture layer precursor” is in reference to the texture layer composition immediately after formation at the substrate 12 and prior to solidification. The “texture layer” (i.e., the texture layer 14) means the formed or imparted texture layer following solidification, including following post-formation processing (e.g., heat, UV, e-beam, etc.) if any. The texture layer composition will include a selected binder resin, a multiplicity of microparticles, and may include additional constituents such as processing agents, mineral(s), filler(s), colorant(s), thickener(s), defoaming agent(s), surfactant(s), soaps, or other cleaning/disinfecting/sanitizing agents etc. Regardless of the exact composition, the texture layer 14 imparts desired manufacturability, scrubbiness, durability, hardness, and abrasion resistance to the scrubbing article 10. The microparticles uniquely enhance scrubbiness and abrasion resistance of the texture layer 14 in accordance with principles of the present disclosure.

A—Ceramic and/or Plastic Microparticles

The microparticles are selected to enhance scrubbing and abrasion resistance properties of the texture layer 14, and can assume a variety of forms. In certain embodiments, the microparticles are made of ceramic material. In other various embodiments, the multiplicity of microparticles are made of plastic microbubbles. The term “microparticles” and the prefix “micro” as used herein (unless an individual context specifically implies otherwise) will generally refer to particles and groups of particles that while potentially varied in specific geometric shape, have an effective, or average, size or diameter that can be measured on a microscale (i.e., in a range of about 0.1 micron to about 500 microns). The term “ceramic” as used throughout the present disclosure is in reference to inorganic, non-metallic materials conventionally classified as ceramics, such as glasses, crystalline ceramics, glass-ceramics, and combinations thereof. The term “ceramic” as used throughout the present disclosure specifically excludes polymers. Some or all of the ceramic microparticles provided with texture layers of the present disclosure can be solid or hollow, and the multiplicity of ceramic microparticles provided with the texture layer 14 can include a combination of solid and hollow microparticles.

In some embodiments, the multiplicity of microparticles is comprised of substantially spherical microparticles (hollow or solid). In this context, “substantially spherical” denotes that a substantial majority (e.g., at least 80% of the total weight of the multiplicity of microparticles, optionally at least 90%, optionally at least 95%) of the microparticles have an exterior shape that deviates no more than 10%, optionally no more than 5%, from a true sphere when viewed on a microscale; alternatively, “substantially spherical” denotes that a substantial majority of the microparticles do not have a plurality of angular cutting edges on the exterior surfaces thereof when viewed on a microscale. Reference to a “substantial majority” recognizes that occasional deviations, deformities, etc., are known to be occasionally encountered in the manufacturing process used to produce the microparticles (for example, somewhat misshapen microparticles may occasionally be produced, two or more microparticles may agglomerate or adhere to each other, and so on).

Individual microspheres comprising the multiplicity of microparticles can have a mean particle size on the order of 0.1-500 microns, optionally on the order of 1-400 microns, optionally on the order of 5-200 microns. The multiplicity of microparticles can have a multimodal (e.g., bimodal or trimodal) size distribution. As used herein, the term “size” is considered to be equivalent with the diameter and height of the microspheres. For the purposes of the present disclosure, the median size by volume can be determined by laser light diffraction by dispersing the microspheres in deaerated deionized water. Laser light diffraction particle size analyzers are available, for example, under the trade designation “SATURN DIGISIZER” from Micromeritics.

In some embodiments, some, a majority, or all of the microparticles are hollow ceramic microspheres and are formed of a glass material (so-called glass microbubbles). Glass microbubbles can be synthesized, for example, by processes or techniques known in the art (see, e.g., U.S. Pat. No. 2,978,340 (Veatch et al.); U.S. Pat. No. 3,030,215 (Veatch et al.); U.S. Pat. No. 3,230,064 (Veatch et al.); U.S. Pat. No. 3,365,315 (Beck et al.); U.S. Pat. No. 4,391,646 (Howell); U.S. Pat. No. 4,767,726 (Marshall); and U.S. Patent Application Publication No. 2006/0122049 (Marshall et al.), which are incorporated herein by reference for their disclosure of silicate glass compositions and method of making glass microbubbles). Glass microbubbles useful with or as the multiplicity of ceramic microparticles of the present disclosure may have, for example, a chemical composition wherein at least 90%, 94%, or even 97% of the glass consists essentially of at least 67% SiO₂ (e.g., a range of 70% to 80% SiO₂), a range of 8% to 15% CaO, a range of 3% to 8% Na₂O, a range of 2% to 6% B₂O₃, and a range of 0.125% to 1.5% SO₃.

Useful glass microbubbles include those available from 3M Company, St. Paul, Minn. under the trade designation “3M GLASS BUBBLES” (e.g., grades K1, K15, S15, S22, K20, K25, S32, S35, K37, XLD3000, S38, S38HS, S38XHS, XLD6000, K46, K42HS, A16/500, G18, H20/1000, H20/1000, D32/4500, H50/10000, S60, 560HS, iM16K, and iM30K); glass bubbles available from Potters Industries, Valley Forge, Pa. (an affiliate of PQ Corporation) under the trade designations “Q-CEL HOLLOW SPHERES” (e.g., grades 30, 6014, 6019, 6028, 6036, 6042, 6048, 5019, 5023, and 5028) and “SPHERICEL HOLLOW GLASS SPHERES” (e.g., grades 110P8 and 60P18); and hollow glass particles available from Silbrico Corp., Hodgkins, Ill. under the trade designation “SIL-CELL” (e.g., grades SIL 35/34, SIL-32, SIL-42, and SIL-43).

In some embodiments, the glass microbubbles have an average true density in a range from 0.1 g/cm³ to 1.2 g/cm³, from 0.1 g/cm³ to 1.0 g/cm³, from 0.1 g/cm³ to 0.8 g/cm³, from 0.1 g/cm³ to 0.6 g/cm³. The term “average true density” is the quotient obtained by dividing the mass of a sample of glass microbubbles by the true volume of that mass of glass microbubbles as measured by a gas pycnometer. The “true volume” is the aggregate total volume of the glass microbubbles, not the bulk volume. For purposes of this disclosure, average true density is measured using a pycnometer (e.g., AccuPcy 1330 from Micromeritics) and can be performed according to ASTM D2840-69, “Average True Particle Density of Hollow Microspheres” or similar protocols known in the art.

In some embodiments, some, a majority, or all of the ceramic microparticles are hollow microspheres and are formed of a ceramic material other than glass. The ceramic microspheres of these optional embodiments can have any of the properties (e.g., size, true density, etc.) described above.

In other embodiments, some, a majority, or all of the microparticles are solid ceramic microspheres. Solid ceramic microspheres can be synthesized, for example, by sol-gel processes, as described for example in U.S. Pat. No. 3,709,706 (Sowman) and U.S. Pat. No. 4,166,147 (Lange et al.). Other methods potentially useful for making solid ceramic microspheres are described in, for example, U.S. Pat. No. 6,027,799 (Castle). Exemplary ceramics include aluminates, titanates, zirconates, silicates, and doped (e.g., lanthanides and actinide) versions thereof. Useful solid ceramic microspheres include those available from 3M Company under the trade designation “3M CERAMIC MICRO SPHERES” (e.g., grades W-210, W-410, and W-619K1, K15, S15, S22, K20, K25, S32, S35, K37, XLD3000, S38, S38HS, S38XHS, XLD6000, K46, K42HS, A16/500, G18, H20/1000, H20/1000, D32/4500, H50/10000, S60, S60HS, iM16K, and iM30K) provided as an alkali alumino silicate ceramic material.

The multiplicity of microparticles provided with the texture layer 14 can consist solely of substantially spherical glass microbubbles as described above, solely of substantially spherical solid ceramic microspheres as described above, solely of substantially spherical plastic microbubbles, or a distribution of glass and/or plastic microbubbles and/or solid ceramic microspheres. The multiplicity of ceramic microspheres comprises no more than 55% by volume of the texture layer 14, optionally no more than 30%, and in some embodiments no more than 10%.

### B—Binder Resin

Useful binder resins in accordance with the present disclosure can assume a wide variety of forms and are generally selected to promote robust securement of the texture layer 14, including the multiplicity of microparticles, to the particular format of the substrate 12. The binder resin can include a resin capable of solidifying or hardening by various mechanisms, such as drying/release of water, exposure to external energy (e.g., heat, UV light, electron beam irradiation, etc.), and with or without crosslinking. Some acceptable binder resins include those binder resins selected from the group consisting of polyolefins, styrene-butadiene resin, acrylic resin, phenolic resin, nitrile resin, ethylene vinyl acetate resin, polyurethane resin, styrene-acrylic resin, vinyl acrylic resin and combinations thereof. Other non-limiting examples of binder resins useful with the present disclosure include amino resins, alkylated urea-formaldehyde resins, melamine-formaldehyde resins, acrylic resins (including acrylates and methacrylates) such as vinyl acrylates, acrylated epoxies, acrylated urethanes, acrylated polyesters, acrylated acrylics, acrylated polyethers, vinyl ethers, acrylated oils, and acrylated silicones, alkyd resins such as urethane alkyd resins, polyester resins, reactive urethane resins, phenolic resins such as resole and novolac resins, phenolic/latex resins, epoxy resins, and the like. The resins may be provided as monomers, oligomers, polymers, or combination thereof. Monomers may include multifunctional monomers capable of forming a crosslinked structure, such as epoxy monomers, olefins, styrene, butadiene, acrylic monomers, phenolic monomers, substituted phenolic monomers, nitrile monomers, ethylene vinyl acetate monomer, isocyanates, acrylic monomers, vinyl acrylic monomer and combinations thereof. Other non-limiting examples of binder resins useful with the present disclosure include amino acids, alkylated urea monomers, melamines, acrylic monomers (including acrylates and methacrylates) such as vinyl acrylates, acrylated epoxies, acrylated urethanes, acrylated polyesters, acrylated acrylics, acrylated ethers, vinyl ethers, acrylated oils, and acrylated silicones, alkyd monomers such as urethane alkyd monomers, esters, and the like.

The binder resin is typically applied as a mixture with water, and optionally, a crosslinking agent that, where desired, promotes optional crosslinking of the polymer in the resin. Example of suitable binder resins with optional crosslinking embodiments of the present disclosure includes, for example, latexes such as a carboxylated styrene-butadiene emulsion available under the trade name Rovene 5900 from Mallard Creek Polymers of Charlotte, N.C. Other examples include Rhoplex TR-407 available from Dow Company of New Jersey and Aprapole SAF17 available from AP Resinas of Mexico City, Mexico. With embodiments in which crosslinking of the selected binder resin is desired, the texture layer composition can include an appropriate crosslinking agent such as, for example, melamine formaldehyde dispersions. Other optional crosslinking initiator, promoter or retardant agents can alternatively be provided as part of the formulation of the texture layer composition (e.g., that assist with optional UV crosslinking and/or e-beam crosslinking or polymerization).

Other binder resins that may be heat curable are an extension of the present disclosure if compatibility with the material of the substrate 12 and with the microparticles is found.

With embodiments in which crosslinking of the selected binder resin is not necessary or intended, the binder resin can assume a variety of forms, and may or may not be a thermoplastic. The non-crosslinking binder resin can be a polyacrylate, modified polyacrylate, polyurethane, polyvinyl acetate, copolyamide, copolyester, or phenolic, as well as other latexes.

The particular binder resin and weight percent relative to the texture layer composition can be fine-tuned to satisfy the desired end application constraints. However, the selected binder resin is characterized as being flowable in matrix form in a manner that will soak only partially, if at all, into the substrate 12 (i.e., will not soak through or wet out the substrate 12) upon forming thereon, and will harden, cure or coalesce optionally upon exposure to various conditions (e.g., heat, UV, e-beam, etc.). Additionally, the binder resin component of the texture layer 14 is optionally non-ionic in some embodiments. The non-ionic nature of the binder resin facilitates use of virtually any form of chemical solution with the scrubbing article 10 where so desired.

### C—Process Agents

As indicated above, the texture layer composition may optionally include additional constituents, such as process agents or aids. For example, the texture layer composition can include a thickening agent or agents to achieve a viscosity most desirable for the particular formation technique (e.g., printing) employed and speed of the manufacturing line. Materials may be selected to have molecular weights or viscosities allowing the texture layer composition or matrix to be flowable in a manner that will fill the holes or voids of a stencil pattern (for example) during transfer of the texture layer composition to the substrate 12, sufficiently adhere to the substrate 12, and to hold the desired pattern shape upon removal of the stencil (or other body) from the substrate 12 even prior to subsequent processing steps (if any). Appropriate thickening agents are known in the art and include, for example, methylcellulose and a material available under the trade designation “RHEOLATE 255” from Rheox, Inc. of Hightstown, N.J. Another acceptable thickening agent is available from Huntsman International LLC, High Point, N.C., USA under the trade designation “LYOPRINT PT-XN”. A thickening agent may be unnecessary depending upon the selected bonder resin and formation technique; however, where employed, the thickening agent preferably comprises less than approximately 40% by weight of the texture layer composition. In other embodiments, a salt component may be provided in the texture layer composition to aid in causing an ionic reaction between components of an emulsion and thereby likewise generate an increase in the viscosity of the composition, as is known in the art.

Anti-foaming agents may be included in the composition to provide defoaming or emulsification of the composition. As described in Ullmann's Encyclopedia of Industrial Chemistry (section “Foams and Foam Control”), some anti-foaming materials are carrier oils; such as water-insoluble paraffinic and naphthenic mineral oils, vegetable oils, tall oil, castor oil, soybean oil, peanut oil; silicone oils, such as dimethylpolysiloxanes; hydrophobic silica; Hydrophobic fat derivatives and waxes, such as fatty acid esters of monofunctional and polyfunctional alcohols, fatty acid amides and sulfonamides, paraffinic hydrocarbon waxes, ozokerite, and montan wax, phosphoric acid mono-, di-, and triesters of short- and long-chain fatty alcohols, short- and long-chain natural or synthetic fatty alcohols, water-insoluble soaps of long-chain fatty acids, including aluminum stearate, calcium stearate, and calcium behenate, perfluorinated fatty alcohols; water-insoluble polymers, such as low molecular mass, fatty acid modified alkyd resins, low molecular mass novolaks, copolymers of vinyl acetate and long-chain maleic and fumaric acid diesters, and methyl methacrylate-vinylpyrrolidone copolymers, poly(propyleneglycols) and high molecular mass propylene oxide adducts to glycerol, trimethylol, propane (1,1,1-tris(hydroxymethyl)propane), pentaerythritol, triethanolamine, dipentaerythritol, polyglycerol, addition products of butylene oxide or long-chain a-epoxides with polyvalent alcohols. An example anti-foaming agent is a silicone emulsion commercially available under the trade designation “XIAMETER AFE-1520” by Dow Corning Corporation of Midland, Mich., USA.

### D—Additives

The texture layer composition optionally includes one or more additives. For example, the texture layer composition can include a colorant or pigment additive to provide a desired aesthetic appeal to the scrubbing article 10. Appropriate pigments are well known in the art, and include, for example, products sold under the trade designation “SUNSPERSE” from Sun Chemical Corp. of Amelia, Ohio. Other coloring agents as known in the art are equally acceptable and in some embodiments comprise less than 10% of the texture layer composition by weight.

In some embodiments, the texture layer 14 optionally further includes a particulate additive (in addition to the microparticles) for enhanced hardness. To this end, and as described in greater detail below, the scrubbing article 10 of the present disclosure is useful in a wide variety of potential applications having different scrubbing requirements. For some applications, it is desirable that the scrubbing article 10, and in particular the texture layer 14, be more or less abrasive than others. While the above-described binder resin component of the texture layer 14, alone or in combination with the above-described microparticles, independently imparts a scrubbiness feature to the article 10 greater than other available scrubbing articles, this scrubbiness characteristic can be further enhanced via the addition of a particulate component. With this in mind, a wide variety of minerals or fillers as known in the art can be employed. Useful minerals include Al₂O₃, “Minex” (available from The Cary Co. of Addison, Ill.), SiO₂, TiO₂, etc. Exemplary fillers include CaCO₃, talc, etc. Where employed, the particulate component additive comprises less than 70% by weight of the texture layer 14, more preferably less than 50% by weight, most preferably less than 30% by weight. Further, the particulate component may consist of inorganic, hard, and small particles. For example, the “Minex” mineral particulate component has a median particle size of 2 microns and a Knoop hardness of about 560. Of course, other particle size and hardness values may also be useful. The optionally inorganic nature of the particulate component, in conjunction with the non-ionic resin component, renders the resulting texture layer 14 amenable for use with any type of chemical solution.

### Chemical Solution

Finally, and as previously described, the scrubbing article 10 of the present disclosure can be used “dry” or can be loaded with a chemical (solution or solid) for disinfecting, sanitizing or cleaning (e.g., a soap). The term “loaded” is in reference to a chemical solution being absorbed by the substrate 12 (or an auxiliary body secured to the substrate 12) prior to being delivered to a user. In addition or alternatively, the chemical may be sprayed onto a surface of the cloth. In still further embodiments, a chemical may be provided in or as part of the texture layer composition 14. Thus, deposited (e.g., printed) texture layer 14 may comprise printed soap scrubbing dots (e.g., 20a, 20b, FIG. 3). With these various constructions, during use, the chemical solution is released from the substrate 12 as the user wipes the scrubbing article 10 across a surface. Thus, in embodiments where the chemical is provided as part of the texture layer 14, the texture layer (i.e., scrubbing portions 20a, 20b) may gradually decrease in size as the chemical is consumed during a scrubbing application. Due to the optional non-ionic nature of the texture layer 14, virtually any desired chemical can be used, including water, soap, quaternary ammonium salt solutions, Lauricidin™-based anti-microbials, alcohol-based anti-microbials, citrus-based cleaners, solvent-based cleaners, cream polishes, anionic cleaners, amine oxides, etc. That is to say, where employed, the chemical solution can be anionic, cationic, or neutral.

### Formation of the Scrubbing Article

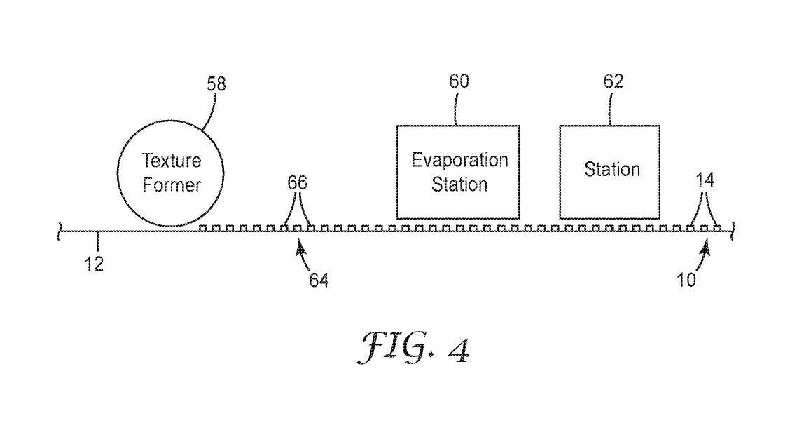

Manufacture or formation of the scrubbing article 10 of the present disclosure is depicted in the simplified block form of FIG. 4 and generally includes formulating the appropriate texture layer composition and imparting the composition onto the substrate 12 (e.g., via printing, coating, etching, embossing, micro-replication, molding, etc.). In some embodiments, methods of the present disclosure optionally further including exposing the texture layer precursor to an energy source that promotes solidification of the texture layer 14. Various techniques for actual depositing or imparting of the composition are described below. As reflected by FIG. 4, some methods of the present disclosure are continuous or in-line, with a continuous web of the substrate 12 being conveyed through various processing stations.

Prior to forming the texture layer composition to the substrate 12, depending upon the type of substrate, the surface 16 (FIG. 2) of the substrate 12 may be primed. Priming may involve mechanical, chemical, physical and material application methods. For example, some surface priming methods that may be especially useful with the present disclosure include consolidating one side of a substrate with the use of heat and/or pressure, flame treating/melting, cutting or removing fiber height such as described in U.S. Provisional Patent Application having Attorney Docket No. 76147US002, incorporated by reference herein above. Alternatively, priming may include application of a chemical primer such as an adhesive. Notably, however, for many substrates 12, no primer is necessary prior to transfer of the texture layer composition onto the substrate 12 to achieve adequate adhesion.

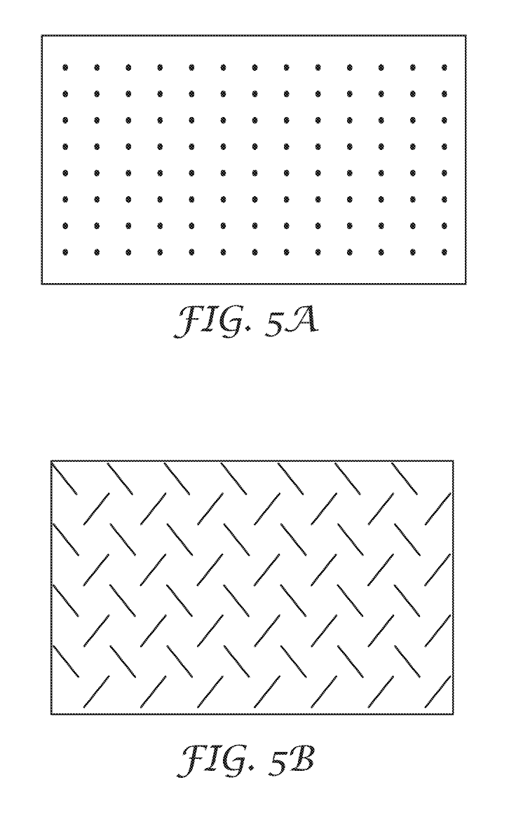

The texture layer composition can be formed on the substrate 12 using a variety of known techniques such as printing (e.g., screen printing, gravure printing, flexographic printing, etc.), coating (e.g., roll, spray, electrostatic), etching, laser etching, injection molding, micro-replication and embossing. In general terms, and with reference to FIG. 4, a texture former (of various types) 58 deposits or prints a texture layer onto the substrate 12 in any desired pattern, such as any of the various patterns described above. The texture former 58 can include, for example, a printer, roll coater, spray coater, etching device, laser embossing equipment, etc. As on specific, non-limiting example, use a printing method for imparting the texture layer 14 may be advantageous in that printing techniques can provide a relatively high-definition application of the texture layer composition. Some printing techniques may also afford relative ease of manufacture and lower cost as compared to other texture forming techniques described above. Regardless of the texture forming technique, as previously described, the texture layer 14 covers less than an entirety of the nonwoven substrate surface on which it is formed (i.e., the surface 16 of FIG. 2), and is preferably formed in a pattern including two or more discrete sections. In this regard, a wide variety of patterns can be formed. For example, the pattern can consist of a plurality of dots as shown in FIG. 1. Alternatively, the pattern can include two (or more) interconnected lines. In yet other embodiments, and with additional reference to FIGS. 5A-5B, the texture layer consists of a plurality of discrete lines, dots, and/or images. Further, other desirable pattern components, such as a company logo, can be formed. Alternatively, a more random distribution of texture layer sections can be imparted to the substrate 12. Virtually any pattern can be obtained.

In some embodiments, the texture layer composition is sufficiently solidified and attached to the substrate 12 immediately after application and/or without post-printing processing. In other embodiments, methods of the present disclosure can include further processing that promotes solidification and/or attachment of the texture layer precursor. For ease of explanation, with embodiments in which the texture layer composition is such that post-printing processing is desirable, an interim scrubbing article 64 can be defined along a length of the continuous substrate 12 immediately downstream of the texture former 58 as identified in FIG. 4, and generally includes a texture layer precursor 66 applied to the substrate 12. The interim scrubbing article 64 may be allowed to remain undisturbed (allowed to wait) for a period of time. Subsequent processing of the interim scrubbing article 64 can include one or more water evaporation stations 60 (e.g., oven, UV light, etc.) located downstream of the texture former 58. As a point of reference, for various texture layer compositions described above, excess water may be present in the binder resin formulation. For example, the texture layer precursor 66, just after transfer to the substrate 12, may contain as much as 40-50%, or more, water. In some embodiments, the retained water may cause the texture layer precursor 66 to lack a desired stability on the substrate 12 (i.e., the texture layer precursor 66 may be subject to damage or alteration such as by contact with another object, a person or other surface of the article, e.g., if the interim scrubbing article 64 is wound upon itself) and a desired level of adhesion to the substrate 12. Also, the water content in the texture layer precursor 66 may impart an undesirable “tackiness” characteristic to the texture layer precursor 66. As defined herein, “tackiness” means slightly adhesive, gummy or sticky to the touch. Therefore, the interim scrubbing article 64 may undergo an optional water evaporation step at the water removal station 60 whereby the interim scrubbing article 64 is exposed to heat (e.g., an oven) or infrared light for a short period of time. Oven and/or infrared light exposure times may vary and may for example be in a range of less than 5 minutes, 3 minutes or less, or 2 minutes or less. With regard to infrared exposure, often infrared light exposure is more cost effective than heating via an oven. However, unless the composition of material undergoing infrared light exposure is naturally highly absorbing of infrared light, an additive may be required to allow absorption of the infrared light by the composition. An example of an additive useful for aiding in infrared absorption is carbon black. Regardless, the water evaporation step can facilitate a stronger or more desirable adherence of the resultant texture layer 14 to the substrate 12 and can provide a more stable, less tacky texture layer 14. It is to be understood that for some texture layer compositions, no excess water is present in the texture layer precursor 66, thus no evaporation step may be desired or necessary. For example, in embodiments of the present disclosure, the texture layer composition comprises a molten polymeric material that does not require a water based resin or compound to achieve material flow sufficient to transfer to a substrate (e.g., 12) in a desired pattern. Rather, as extruded, the molten polymeric material can be deposited (e.g., printed, coated, etc.) directly onto the substrate 12. The molten polymer material may flow under pressure to the substrate 12 and then cool and solidify on the substrate 12 to form the texture layer precursor 66.

Notably and advantageously, the interim scrubbing article 64, either prior or subsequent to the wait period and/or the evaporation step, may be formed into a roll (a rolled interim article 64 and roll-forming step are not shown) in a manner of material winding as is known in the art. As described above, the texture layer composition may have a molecular weight and/or viscosity that advantageously allows for this type of roll-forming prior to optional, subsequent treatment of the texture layer precursor 66.

In some embodiments, the texture layer precursor 66 solidifies, cures, hardens, coalesces, or otherwise transitions to the final texture layer 14 and is sufficiently attached to the substrate 12 following processing at the water evaporation station 60 without further active steps (i.e., the interim scrubbing article 64 is converted to the final scrubbing article 10 after processing by the water evaporation station 60). In other embodiments, the interim scrubbing article 64 can be subjected to other processing steps. For example, after the texture layer precursor 66 has been imparted to the substrate 12, and after any or all of the optional wait period, evaporation, or roll-forming steps described above, the interim scrubbing article 64 can optionally be subjected to processing at a crosslinking or polymerization station 62 adapted to promote crosslinking or polymerizing, or both, of the texture layer composition formed thereon. For example, the station 62 can be configured to generate electron beam (e-beam) or ultraviolet (UV) radiation that irradiates the texture layer precursor 66 of the interim scrubbing article 64 to thus forming the resultant scrubbing article 10. Optional e-beam or UV radiation steps and corresponding texture layer compositions are described in U.S. Provisional Patent Application having Attorney Docket No. 76109US002, entitled “Scrubbing Article and Method of Making Same” and U.S. Provisional Patent Application having Attorney Docket No. 76148US002, entitled, “UV Treated Scrubbing Articles and Methods of Making Same”, each filed on even date herewith and incorporated by reference herein in their respective entireties.

Regardless of the exact substrates 12 or compositions, dimensions and pattern of the texture layer 14, the scrubbing article 10 of the present invention provides a marked improvement over previous consumer scrubbing articles in terms of cost, and ease and flexibility of manufacturing processes. In addition, scrubbing articles of the present disclosure exhibit suitable abrasion resistance performance and may beneficially be devoid of residual chemicals in the texture layer 14. Exemplary scrubbing articles 10 are provided below. The components and/or weight percent amounts provided by the compositions can readily be varied, yet fall within the scope of the present disclosure.

### Examples

Objects and advantages of the present disclosure are further illustrated by the following non-limiting examples and comparative examples. The particular materials and amounts thereof recited in these examples, as well as other conditions and details, should not be construed to unduly limit the present disclosure.

Unless otherwise noted, all parts, percentages, ratios, etc. in the Examples and the rest of this specification are by weight.

Abbreviations for materials and reagents used in the examples are as follows:
Latex: Carboxylated styrene-butadiene emulsion with a Brookfield viscosity of 200 cps (#2/20 rpm) and pH of 9.0, commercially available under the trade designation “ROVENE 5900” from Mallard Creek Polymers, Inc., Charlotte, N.C., USA.
Pigment: Liquid white pigment with a density of 1.984 g/cc, commercially available under the trade designation “WHD9507 SUNSPERSE WHITE 6” from Sun Chemical Corporation, Cincinnati, Ohio, USA.
Thickener: Fully neutralized, anionic acrylic polymer dispersion with a specific gravity of 1.1, commercially available under the trade designation “LYOPRINT PT-XN” from Huntsman International LLC, High Point, N.C., USA.
Silicone Emulsion: Silicone emulsion with a specific gravity of 1.0 and with a pH of 3.5, commercially available under the trade designation “XIAMETER AFE-1520” from Dow Corning Corp., Midland, Mich., USA.
GB-1: 3M™ iM16K Hi-Strength Glass Bubbles with 110 MPa crush strength, 20 micron average diameter and 0.46 g/cm³ true density, commercially available from 3M Company, St. Paul, Minn. under the trade designation “3M iM16K Hi-Strength Glass Bubbles”.
GB-2: 3M™ iM16K-N Hi-Strength Glass Bubbles, treated for surface neutrality, with 110 MPa crush strength, 20 micron average diameter and 0.46 g/cm³ true density commercially available from 3M Company, St. Paul, Minn. under the trade designation “3M iM16K-N Hi-Strength Glass Bubbles”.
CM-1: Hard, inert, solid, white-colored, fine ceramic spherical particles with a typical whiteness (L Value) of 95 or greater, a particle size of 3 microns, and a density of 1.5 g/cm³, commercially available from 3M Company, St. Paul, Minn. under the trade designation “3M W210 Ceramic Microspheres”.
CM-2: Hard, inert, solid, white-colored, fine ceramic spherical particles with a typical whiteness (L Value) of 95 or greater, a particle size of 10 microns, and a density of 1.5 g/cm³, commercially available from 3M Company, St. Paul, Minn. under the trade designation “3M W610 Ceramic Microspheres”.
Plastic Film: Melt extruded, biaxially oriented and primed poly(ethylene terephthalate) film with a thickness of 0.13 mm.
Fabric: A knitted fabric prepared from 82% poly(ethylene terephthalate) and 18% polyamide 6 fibers, having a thickness in the range of 0.45-0.75 mm and a unit weight of 160 g/m².
Nonwoven Wipe: Thermally point-bonded spunbond poly(ethylene terephthalate) non-woven wipe with a unit weight of 70 g/m².
Foam: Polyurethane foam sheet with a density of 27 kg/m³, with a thickness of 2.54 cm, and with a relatively non-porous top and bottom surfaces, commercially available under the trade designation “TEXTURED SURFACE FOAM, POLYETHER, M-100SF” from Aearo Technologies LLC, Newark, Del., USA.
Cellulose Sponge: Cellulose sponge sheet commercially available under the trade designation “SCOTCH-BRITE STAY CLEAN SCRUBBING DISH CLOTH” with a catalog number of 9033-Q from 3M Company, St. Paul, Minn.

### Texture Layer Composition Example A

A texture layer composition in accordance with principles of the present disclosure was prepared by weighing to the nearest 0.1 gram the Latex, Pigment, Thickener, Silicone Emulsion and GB-1 ingredients as listed in Table 1. All ingredients were placed in a rigid plastic container. A plastic lid was placed on the container. The mixture was mixed for 30 second in a laboratory centrifugal mixer commercially available from Flaktek, Inc., Landrum, S.C., USA under the trade designation “SPEEDMIXER DAC 400.1 VAC-P”. After 30 seconds, the mixture was stopped, and the plastic container which had the mixture in it was removed from the mixer. The container was left undisturbed on a laboratory bench for 24 hours.

### Texture Layer Composition Example B

The texture layer composition of Example B included the same ingredients as Example A (in the amounts specified in Table 1) and was prepared in the same manner, except that GB-1 was replaced by GB-2.

### Texture Layer Composition Example C

The texture layer composition of Example C included the same ingredients as Example A (in the amounts specified in Table 1) and was prepared in the same manner, except that GB-1 was replaced by CM-1.

### Texture Layer Composition Example D

The texture layer composition of Example D included the same ingredients as Example A (in the amounts specified in Table 1) and was prepared in the same manner, except that GB-1 was replaced by CM-2.

### Texture Layer Composition Comparative Example

The texture layer composition of the Comparative Example included the same ingredients as Example A (in the amounts specified in Table 1) and was prepared in the same manner, except that GB-1 was not included (nor was any other ceramic microparticle material).

TABLE 1
Texture Layer Compositions

| | Ex. A | Ex. B | Ex. C | Ex. D | Comp Ex. |
|---|---|---|---|---|---|
| | weighot | oweight | oweight | oweight | weight |
| Component | (g) | (g) | (g) | (g) | (g) |
| Latex | 90 | 90 | 85.4 | 85.4 | 95 |
| Pigment | 3 | 3 | 2.7 | 2.7 | 3 |
| Silicone | 0.2 | 0.2 | 0.2 | 0.2 | 0.2 |
| Emulsion | | | | | |
| Thickener | 1.8 | 1.8 | 1.7 | 1.7 | 1.8 |
| GB-1 | 5 | 0 | 0 | 0 | 0 |
| GB-2 | 0 | 5 | 0 | 0 | 0 |
| CM-1 | 0 | 0 | 10 | 0 | 0 |
| CM-2 | 0 | 0 | 0 | 10 | 0 |
| TOTAL | 100 | 100 | 100 | 100 | 100 |

Five sample scrubbing articles were prepared for each of the Example A-D and Comparative Example texture layer compositions by pattern printing each of the Example A-D and Comparative Example texture layer compositions onto various substrates. In particular, a rectangular specimen of each of the Film, Fabric, Nonwoven Wipe, Foam, and Cellulose Sponge substrates was obtained for each of texture layer compositions of Examples A-D and Comparative Example with approximate dimensions of 30 cm×20 cm. Each substrate specimen was, in turn, secured on a flat laboratory bench by applying adhesive tape on its edges for subsequent printing of the prepared Examples and Comparative Example texture layer compositions thereon.

For each of the prepared substrates, a metal stencil with the pattern shown in FIG. 1 was placed on top of the substrate specimen. Approximately 100 grams of the prepared texture layer composition was placed on the stencil with the help of a wooden applicator (e.g., the texture layer composition of Example A was placed on the stencil applied to a Film substrate specimen, the stencil applied to a Fabric substrate specimen, the stencil applied to a Nonwoven Wipe substrate specimen, the stencil applied to a Foam substrate specimen, and the stencil applied to a Cellulose Sponge substrate specimen). The texture layer composition was applied on the printing pattern of the corresponding stencil with a shearing motion while applying hand pressure downwards and with the help of a hand-held squeegee. It was observed that for each specimen, the texture layer composition filled the holes of the printing pattern and was transferred onto the substrate specimen. Then, the stencil was removed and the printed substrate specimen was left undisturbed on a laboratory bench for 10 minutes. After 10 minutes, the printed specimen was placed in a laboratory hot air circulating oven (Model VRC2-35-1E, commercially available from Despatch Industries, Minneapolis, Minn., USA) for 3 minutes. The temperature of the oven was set to 149° C. After 3 minutes, the printed specimen was taken out of the oven and was left undisturbed on a laboratory bench for 24 hours to provide a sample scrubbing article.

### Abrasion Resistance Testing Procedure for the Sample Scrubbing Articles

The abrasion resistance of the sample scrubbing articles was tested by rubbing a hand-held scouring pad (commercially available under the trade designation of EXTREME SCRUB HAND PAD from 3M Company, St. Paul, Minn., USA) onto each of the samples with the hand pressure. Each tested scrubbing article sample was placed on a flat laboratory bench and secured onto the bench by applying adhesive tape on its corners. The scouring pad was thoroughly washed under running tap water and squeezed by hand 5 times to remove any excess water absorbed by the pad. Then, the scouring pad was rubbed back and forth on the sample scrubbing article by only applying slight hand pressure with a shearing motion. The combination of each back and forth motion was considered to form a cycle. Each sample scrubbing article was visually observed after 20 cycles and the extent of abrasion resistance was evaluated or rated as described in Table 2.

TABLE 2
Abrasion Resistance Evaluation Ratings

| Strength | |
|---|---|
| of | |
| abrasion | |
| resistance | Description |
| 9 | The printed pattern was only slightly abraded after 20 cycles. |
| | Most of the printed pattern stayed intact on the substrate or |
| | the substrate was worn off before the pattern did |
| | (cohesive failure). |
| 3 | The printed pattern showed a certain level of abrasion |
| | resistance. The pattern did not easily wear off, however it was |
| | still possible to remove it from the substrate. No cohesive |
| | failure was observed. |
| 1 | The printed pattern did not show significant abrasion |
| | resistance. The pattern was abraded with relative ease. |

### Results

The abrasion resistance test results are presented in Table 3. The results indicated that the presence of small ceramic microparticles (CM-1; Example C) was more useful as compared to larger ceramic microparticles (CM-2; Example D) and glass microbubbles (GB-1 and GB-2; Examples A and B). In addition, it was also evident that the neat glass microbubbles (GB-1; Example A) were more useful as compared to the surface modified glass microbubbles (GB-2; Example B). It was apparent that the cellulose sponge showed an average performance. Although not wishing to be bound by any theoretical consideration, it is contemplated that the average performance of the cellulose sponge may have resulted from a lack of substantial extent of functional chemical groups on the cellulose sponge surface that in turn limited the extent of interfacial bonding between the cellulose sponge and the printed compositions.

TABLE 3
Abrasion Resistance of Sample Scrubbing Articles

| | Substrate | | | | |
|---|---|---|---|---|---|
| Texture Layer | | | | | Cellulose |
| Composition | Plastic film | Fabric | Nonwoven | Foam | Sponge |
| Ex. A | 3 | 9 | 3 | 9 | 1 |
| Ex. B | 1 | 9 | 3 | 9 | 1 |
| Ex. C | 9 | 9 | 3 | 9 | 1 |
| Ex. D | 3 | 9 | 3 | 9 | 1 |
| Comp. Ex. | 9 | 9 | 3 | 9 | 1 |

The scrubbing articles of the present disclosure provide a marked improvement over previous designs. By incorporating microparticles into the texture layer composition, a scrubbing article can be provided with enhanced abrasion resistance.

Although the present disclosure has been described with reference to preferred embodiments, workers skilled in the art will recognize that changes can be made in form and detail without departing from the spirit and scope of the present disclosure.

What is claimed is:

1. A scrubbing article comprising:
a substrate; and
a texture layer formed on at least one surface of the substrate, the texture layer including a multiplicity of ceramic microparticles.

2. The scrubbing article of claim 1, wherein at least some of the ceramic microparticles are solid microspheres.

3. The scrubbing article of claim 1, wherein at least some of the ceramic microparticles are hollow microspheres.

4. The scrubbing article of claim 3, wherein at least some of the hollow microspheres are glass microbubbles.

5. The scrubbing article of claim 1, wherein the multiplicity of microparticles are substantially spherical.

6. The scrubbing article of claim 5, wherein at least 95% of the microparticles of the multiplicity of ceramic microparticles have an outer shape that is within 5% of a truly spherical shape.

7. The scrubbing article of claim 1, wherein the substrate includes a material selected from the group consisting of a nonwoven web, a woven web, a knitted web, foam, cellulose sponge, and a film.

8. The scrubbing article of claim 1, wherein the texture layer further includes a binder resin.

9. The scrubbing article of claim 8, wherein the binder resin includes a latex.

10. The scrubbing article of claim 8, wherein the binder resin is configured to harden without crosslinking.

11. The scrubbing article of claim 8, wherein the texture layer further includes a crosslinking agent.

12. The scrubbing article of claim 1, wherein the texture layer defines a pattern on the surface of the substrate.

13. The scrubbing article of claim 1, wherein the texture layer is an e-beam treated texture layer.

14. A method of producing a scrubbing article comprising:
providing a substrate; and
forming a texture layer onto a surface of the substrate, the texture layer including a multiplicity of ceramic microparticles.

15. The method of claim 14, wherein the step of forming a texture layer includes:
providing a flowable texture layer composition; and
transferring the flowable texture layer composition onto the surface of the substrate.

16. The method of claim 14, wherein at least some of the ceramic microparticles are solid microspheres.

17. The method of claim 14, wherein at least some of the ceramic microparticles are hollow microspheres.

18. The method of claim 17, wherein at least some of the hollow microspheres are glass microbubbles.

19. The method of claim 14, wherein the multiplicity of ceramic microparticles are substantially spherical.

20. The method of claim 19, wherein at least 95% of the microparticles of the multiplicity of ceramic microparticles have an outer shape that is within 5% of a truly spherical shape.
